(19) United States
(12) Patent Application Publication
(10) Pub. No.: US 2026/0163714 A1
(43) Pub. Date: Jun. 11, 2026

(54) TIMING CRITICAL CONTROL CIRCUIT

(71) Applicant: SKYWORKS SOLUTIONS, INC., Irvine, CA (US)

(72) Inventors: Sreedhar Vineel Reddy Kaipu, San Jose, CA (US); Shao-Min Hsu, San Jose, CA (US); Daniel Chang, Mountain View, CA (US); Yeung Bun Choi, Singapore (SG); James Henry Ross, Cedar Rapids, IA (US); Bryan J. Roll, Cedar Rapids, IA (US); Sener Yuki Yalcin, San Jose, CA (US)

(21) Appl. No.: 19/318,633

(22) Filed: Sep. 4, 2025

Related U.S. Application Data
(60) Provisional application No. 63/692,903, filed on Sep. 10, 2024.

(51) Int. Cl. H04L 7/08; G06F 13/40

(52) U.S. Cl. CPC H04L 7/08; G06F 13/4022

(57) ABSTRACT

A method for sending timing-critical instructions in a system, including transmitting a plurality of bits to a device having a switching controller, the plurality of bits being divided into a first set and a second set, by transmitting the first set during one or more first clock cycles, pausing for a period of time after transmitting the first set, and transmitting the second set during one or more second clock cycles.

### CROSS-REFERENCE TO RELATED APPLICATIONS

This application claims priority under 35 U.S.C. § 119(e) to U.S. Provisional Patent Application no. 63/692,903, titled TIMING CRITICAL CONTROL CIRCUIT, filed on Sep. 10, 2024, which is hereby incorporated in its entirety for all purposes.

### BACKGROUND

### 1. Field of the Disclosure

At least one example in accordance with the present disclosure relates generally to control signals for electronic devices.

### 2. Discussion of Related Art

Telecommunication systems (e.g., 5G, 6G, and so forth) are growing increasingly fast in response to demands from consumers for speed. Front-end modules in telecommunication devices (such as phones and radios) handle receiving and sending the high frequency signals used to carry data in these telecommunication systems.

### SUMMARY

According to at least one aspect of the present disclosure, a method is presented for sending timing-critical instructions in a system, comprising: transmitting a plurality of bits to a device having a switching controller, the plurality of bits being divided into a first set and a second set, by transmitting the first set during one or more first clock cycles, pausing for a period of time after transmitting the first set, and transmitting the second set during one or more second clock cycles.

In some examples, the first set contains timing-critical instructions for the device, wherein the timing-critical instructions cannot be timely processed if received after the first period of time. In some examples, the first set and the second set are exclusive sets of bits. In some examples, the device is a switching device. In some examples, the method further comprises transmitting each respective bit of the first set during a respective clock cycle of the one or more first clock cycles. In some examples, the method further comprises transmitting each respective bit of the second set during a respective clock cycle of the one or more second clock cycles. In some examples, one or more instructions corresponding to the first set begin to be processed by the device prior to the one or more second clock cycles. In some examples, the device executing the instructions includes adjusting states of one or more switches in the device. In some examples, the device is a telecommunication device. In some examples, during the period of time, and prior to execution of the instructions corresponding to the first set, each bit of the first set is saved into a register located in the device. In some examples, positions of each bit of the first set are adjusted such that the first set occupies positions in the register corresponding to timing-critical controls of the device. In some examples, adjusting the positions of each bit of the first set includes shifting each bit of the first set by a predetermined amount. In some examples, transmitting the second set follows pausing for the period of time after transmitting the first set. In some examples, each bit of the second set is saved into the register after the period of time. In some examples, one or more instructions corresponding to the second set are executed by the device.

According to at least one aspect of the present disclosure, a telecommunication system is presented, comprising: a transmitter configured to transmit outgoing signals; a receiver configured to receive inbound signals; one or more switches for routing inbound signals to one or mor first circuit elements and outgoing signals from one or more second circuit elements; and a controller configured to send one or more control signals to the one or more switches, the one or more control signals controlling the one or more switches to change states between transmitting and receiving states at high frequencies.

In some examples, the controller receives instructions that determine the one or more control signals, the instructions being contained in packets of bits, wherein each packet is separated into a first set of bits and a second set of bits. In some examples, the controller receives the first set during a first period of time and the second set during a second period of time. In some examples, the first set of time precedes the second set of time by a pause, the pause being a third period of time having a length greater than one clock cycle of a clock of the system. In some examples, the first set contains bits corresponding to timing-critical instructions, the timing-critical instruction being instructions that should begin to be executed prior to the second time period. In some examples, the controller executes the timing-critical instructions during the pause following receipt of the first set. In some examples, the controller executes the timing-critical instructions by generating at least one control signal of the one or more control signals. In some examples, executing the timing-critical instructions includes saving each respective bit of the first set of bits to a respective position in a register. In some examples, saving each respective bit of the first set to a respective position in the register includes shifting the first set by a predetermined amount. In some examples, the controller further saves each respective bit of the second set to a respective position in the register following the pause. In some examples, the controller further generates at least one control signal of the one or more control signals based on the second set.

According to at least on aspect of the present disclosure, a non-transitory computer-readable medium is presented, containing thereon instructions for managing timing-critical instructions, the instructions instructing at least one processor to: transmit a plurality of bits to a device having a switching controller, the plurality of bits being divided into a first set and a second set, by transmit the first set during one or more first clock cycles, perform a pause after transmitting the first set, and transmit the second set during one or more second clock cycles; wherein the first set contains timing-critical instructions for the device; wherein the first set and the second set are exclusive sets of bits; wherein the device is a switching device; and transmitting each respective bit of the first set occurs during a respective clock cycle of the one or more first clock cycles, transmitting each respective bit of the second set occurs during a respective clock cycle of the one or more second clock cycles, and one or more timing-critical instructions corresponding to the first set are executed by the device during the pause.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a switching system according to an example;

FIG. 2 illustrates a packet of data according to an example; and

FIG. 3 illustrates a timing-diagram according to an example.

### DETAILED DESCRIPTION

Front-end modules (FEMs) discussed herein may contain transmitters and receivers, multiple filters, and complex switching layouts for routing signals (whether transmitted or received) to the appropriate filters or otherwise along the correct signal paths. Examples of switching topologies to illustrate this high level of complexity will be discussed below. In many examples, a controller (which may be a single circuit or a combination of various circuits) may provide instructions to the switches dictating which connections should be “on” (e.g., in use), and which connections should be “off” (e.g., not in use). However, at high frequences, such as those used in 5G communications and other emerging communication protocols (e.g., 6G), the frequency of the transmitted and/or received signals can be high, in some cases so high that timing critical instructions (for example, instructions that determine the states of the switches) cannot be transmitted to the switches fast enough for the switches to change states in time to properly process and/or route the signals.

Various solutions can be used to address the timing issue discussed above. In one, additional GPIO (general purpose input/output) pins may be used. However, this solution grows in complexity at a rapid rate as the number of bits being transmitted in a given packet of data or over a given period of time increases. For example, each GPIO pin may need multiple connections (at least as many connections as there are bits, in some examples) to properly function, which will consume a large amount of resources and area on the chip (e.g., on the die). This makes using GPIO pins a resource-intensive and complicated method of handling transmitting control signals to the switches.

A second solution increases the number of data lines available. This increases control signal bandwidth, but also requires additional resources and area to provide for the additional data lines. The complexity remains relatively high, as does the resource expense.

Aspects of this disclosure relate to a novel dual-enable method for transmitting control signals, one in which timing critical control signals are transmitted first, followed by the rest of a given packet. In contrast to the above solutions, this solution lacks complexity and requires little to no additional area or resources. However, a trade-off exists, as this method can, in some examples, be slower than the two solutions discussed above and may also have a longer total transmission time than a single-enable approach.

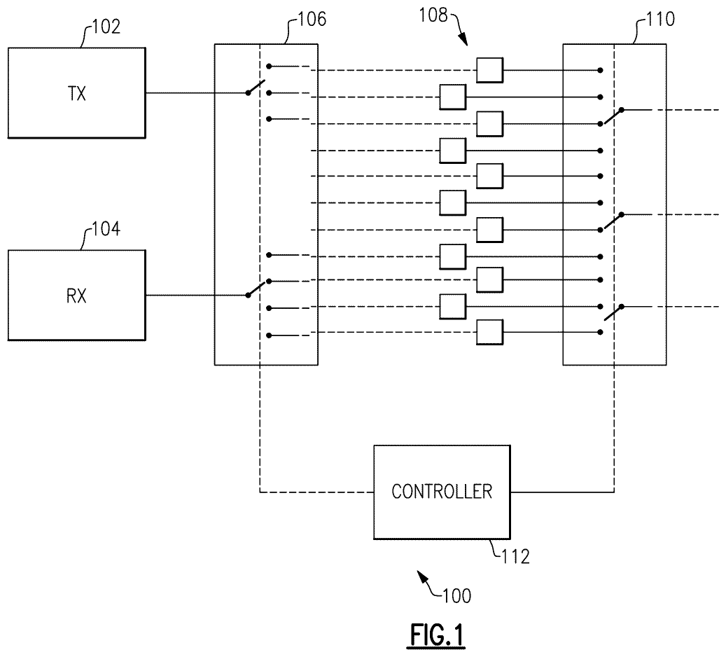

FIG. 1 illustrates a switching system 100 in a front-end module (FEM) according to an example. The system 100 includes a transmitter 102, a receiver 104, a first plurality of switches 106, a plurality of filters 108, a second plurality of switches 110, and a controller 112.

The first plurality of switches 106 has at least two input terminals, and one or more output terminals. As illustrated, two input terminals are shown, and six output terminals are shown, though there may be any number of input and/or output terminals. The input terminals may be configured to selectively couple to one or more of the output terminals. Also, the terms input terminal and output terminal are used for convenience herein: the input terminals may be used for input or output, as may the output terminals.

The transmitter 102 is coupled to a first input terminal of the first plurality of switches 106. The receiver 104 is coupled to a second input terminal of the first plurality of switches.

The output terminals of the first plurality of switches 106 are coupled, directly or indirectly, to respective filters of the plurality of filters 108. For example, the first output terminal of the first plurality of switches 106 may be coupled to a respective first filter of the plurality of filters 108, the second output terminal may be coupled to a respective second filter, and so forth.

The second plurality of switches 110 has one or more input terminals and one or more output terminals. As illustrated, there are eleven input terminals and three output terminals. Each input terminal is coupled to a respective filter of the plurality of filters 108. Each output terminal may be configured to selectively couple to one or more of the input terminals. The output terminals may also be coupled to respective other circuits or systems.

The system 100 has a large number of potential configurations, and may need to switch between configurations at a high frequency equal to or greater than the frequency of the signals being transmitted and received.

The controller 112 is communicatively coupled to the first and second plurality of switches 106, 110, and is configured to control the state of each switch. That is, the controller 112 may determine which input terminals are coupled to which output terminals, and during what periods of time said states persist. The controller 112 may receive, generate, or transmit control signals in a serial fashion. For example, the controller 112 may package, transmit and/or receive instructions as a packet of data having a plurality of bits. Each bit (or certain subsets of bits) may correspond to instructions that can change the state of the system. Some of the instructions may be related to time-critical controls, like the state of switches in the transmit and receive paths, while other instructions may not be time-critical (e.g., instructions managing a temperature sensor that operates at a lower frequency than the switches need to operate).

The controller 112 can then transmit the time-critical bits first, and later supplement those bits with additional bits related to the rest of the instructions. In other words, the controller 112 can transmit part of the packet first, and then, after a short delay that may correspond to the time to transmit the part of the packet, the rest of the packet can be transmitted.

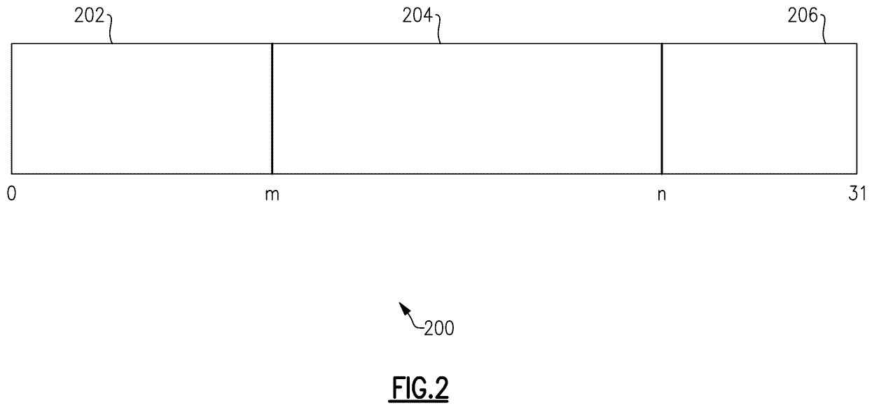

FIG. 2 illustrates a packet 200 of data according to an example. The packet 200 is 32 bits wide (from bit 0 to bit 31). The packet 200 could have any width (e.g., 1 bit, 10 bits, 20 bits, 28 bits, 63 bits, or any other number). The packet 200 of FIG. 2 is further divided into three sections, a first section 202, a second section 204, and a third section 206. The first section 202 may contain a first instruction (or set of instructions), the second section 204 may contain a second instruction (or set of instructions), and the third section 206 may contain a third instruction (or set of instructions).

Any of the sections 202-206 may contain timing-critical instructions. However, in at least some examples, the timing-critical instructions may all be allocated to a single, contiguous section. For example, the timing-critical instructions may be allocated to the third section 206. In some examples, the bits corresponding to the timing-critical instructions may be received before bits that are not timing-critical. In this example, where the third section 206 contains the timing-critical instructions, bits n+1 through 31 may be received first, before bits 0 through n. However, in other examples, the timing-critical instructions could be contained in bits 0 through m and thus the first section 202 could be received first. In other examples, timing-critical bits may be dispersed throughout the packet 200 and may be received prior to other bits, or in any other order. However, in general, configurations where the timing-critical bits are contiguous and received first may be the simplest to implement.

Hereafter, it will be assumed that the third section 206 contains the timing-critical instructions for the purpose of further explanation.

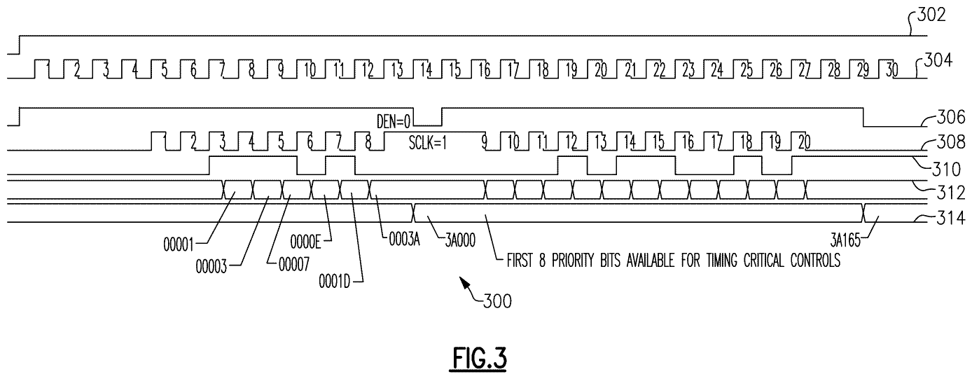

FIG. 3 illustrates a timing diagram 300 according to an example. The timing diagram 300 includes a first trace 302 corresponding to a first enable signal, a second trace 304 corresponding to a system clock signal, a third trace 306 corresponding to a second enable signal, a fourth trace 308 corresponding to a controller clock signal, a fifth trace 310 corresponding to the instructions issued by the controller (e.g., controller 112), a sixth trace 312 corresponding to hexadecimal values for the instructions during certain clock cycles, and a seventh trace 314 corresponding to hexadecimal values for instructions issued to a front-end module, for example, a front-end module containing the switching system 100 of FIG. 1 or a similar switching system.

Each of the first through fifth traces 302-310 have high and low states (corresponding to logical 1 and 0). When the first trace 302 is high, the controller (e.g., controller 112) is enabled and may perform functions generally. The first trace 302 may also enable or disable other aspects of the front-end module in some examples.

When the third trace 306 is high, the controller 112 is configured to receive and/or generate control signals. When the third trace 306 goes from high to low (e.g., on a falling edge), the controller 112 is configured to transmit such instructions as it has received or generated up to that point.

When the fourth trace 308 goes from high to low (e.g., a falling edge), the controller 112 is configured to assign to the one or more bits the respective values of one or zero based on the fifth trace 310 (in some examples, this may take the form of incrementing a value stored in a register by one or more). Specifically, if the fifth trace 310 is high and the fourth trace 308 has a falling edge the controller 112 may shift the values in the register (or other memory) to the left by one and then assign a value of one to the least significant bit. If the fifth trace 310 is low and the fourth trace 308 has a falling edge, the controller 112 may shift the values of the register (or other memory) to the left by one and then assign a value of zero to the least significant bit. Other configurations are also possible, such as configurations that add linearly to the value.

Having explained the functions corresponding to the first through fifth traces 302-310, the sixth trace 312 simply contains the value of the instruction (e.g., the value in the register or registers) during a given period of time. Note that the register may be part of or separate from a controller, such as the controller 112 or as part of a switch (such as the pluralities of switches 106, 110). This value of the instruction may, in some example, be updated with the falling edge of the fourth trace 308. The seventh trace 314 in turn contains the value of the instructions transmitted by the controller 112, for example, instructions transmitted to the pluralities of switches 106, 110 and/or any other part of the front-end module or switching system 100.

As is illustrated in FIG. 3, after a certain number of cycles of the controller clock signal illustrated by the fourth trace 308, the clock signal remains high for a relatively long period of time (about 3.5 times the period of the controller clock signal and/or the system clock signal, though the multiple may be any value, e.g., 1.5, 0.5, 1.73, and 2, and so forth). During this period of time (which follows the eighth falling edge in the timing diagram 300 as illustrated, and precedes the ninth falling edge), the third trace 306 has a falling edge and a rising edge. During the falling edge of the third trace 306, the value corresponding to the first eight bits (h0003A in FIG. 3) is transmitted to the timing sensitive elements of the switching system 100 and/or front-end module and also shifted left to the most significant bit (so that the value transmitted is h3A000). The length of time between the eighth falling edge and ninth falling edge ensures the transmission of the current value (as indicated in the sixth trace 312) is complete before additional alterations to the value are made. The third trace 306 again experiences a falling edge after all values for the packet are received, at which point the value of the transmitted data as indicated in the seventh trace 314 is updated to reflect any changes. It should be noted that the value of the timing-critical portion of the instructions does not change as a result of the second falling edge of the third trace 306 (that is, the transmitted value, in the illustrated example, retains the hexadecimal value of h3A in the most significant bit location. Only the zeroes are altered, for a final value of h3A165). It will be appreciated that the specific values in FIG. 3 have no particular meaning (there is no significance to h3A000, h3A165, or any other value indicated). These values are purely examples for explanatory purposes.

Returning to FIG. 2, it can be considered that the third section 206 of the packet 200 may correspond to the “h3A” value in FIG. 3 that is transmitted during the period of time between the eighth and ninth falling edges. That is, the third section 206 of the packet 200 may be transmitted when the third trace 306 has its first falling edge, such that the timing-critical instructions in the third section 206 are transmitted prior to the rest of the data. In such an example, the first and second sections 202, 204, which do not contain timing-critical data, would correspond to the value “h165” transmitted responsive to the second falling edge of the third trace 306.

Referring more generally to the method and systems disclosed above, transmitting the timing-critical instructions in the manner described (e.g., in FIG. 3) provided a substantial improvement in switching turn-on times and/or switching state changes compared to single-enable implementations. In particular, turn-on times of approximately 1 μs or more were reduced by approximately 20% and were lowered below 1 μs. That is, the switches were able to change state in less than 1/1000^{th} of a second.

By contrast, a single-enable approach (in which only one enable signal is used, and the entire packet 200 is transmitted during the falling edge of that enable signal), switching times exceeded 1 μs, as mentioned above. However, under the single-enable approach, the entire packet 200 may be transmitted more quickly than in the double-enable approach because the single-enable approach does not require a delay to transmit the timing-critical instructions. To put it another way, the double-enable approach transmits the timing-critical instructions significantly faster than the single-enable approach, but may not transmit the rest of the instructions as quickly as the single-enable approach would.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 112, may execute various operations discussed above. Using data stored in associated memory and/or storage, the controller 112 also executes one or more instructions stored on one or more non-transitory computer-readable media, which the controller 112 may include and/or be coupled to, that may result in manipulated data. In some examples, the controller 112 may include one or more processors or other types of controllers. In one example, the controller 112 is or includes at least one processor. In another example, the controller 112 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method for sending timing-critical instructions in a system, comprising:
transmitting a plurality of bits to a device having a switching controller, the plurality of bits being divided into a first set and a second set, by
transmitting the first set during one or more first clock cycles,
pausing for a period of time after transmitting the first set, and
transmitting the second set during one or more second clock cycles.

2. The method of claim 1 wherein the first set contains timing-critical instructions for the device, wherein the timing-critical instructions cannot be timely processed if received after the first period of time.

3. The method of claim 1 wherein the first set and the second set are exclusive sets of bits.

4. The method of claim 1 further comprising transmitting each respective bit of the first set during a respective clock cycle of the one or more first clock cycles, and transmitting each respective bit of the second set during a respective clock cycle of the one or more second clock cycles.

5. The method of claim 1 wherein one or more instructions corresponding to the first set begin to be processed by the device prior to the one or more second clock cycles.

6. The method of claim 5 wherein the device executing the instructions includes adjusting states of one or more switches in the device.

7. The method of claim 5 wherein, during the period of time, and prior to execution of the instructions corresponding to the first set, each bit of the first set is saved into a register located in the device.

8. The method of claim 7 wherein positions of each bit of the first set are adjusted such that the first set occupies positions in the register corresponding to timing-critical controls of the device.

9. The method of claim 8 wherein adjusting the positions of each bit of the first set includes shifting each bit of the first set by a predetermined amount.

10. The method of claim 9 wherein transmitting the second set follows pausing for the period of time after transmitting the first set.

11. The method of claim 10 wherein each bit of the second set is saved into the register after the period of time.

12. A telecommunication system comprising:
a transmitter configured to transmit outgoing signals;
a receiver configured to receive inbound signals;
one or more switches for routing inbound signals to one or mor first circuit elements and outgoing signals from one or more second circuit elements; and
a controller configured to
send one or more control signals to the one or more switches, the one or more control signals controlling the one or more switches to change states between transmitting and receiving states at high frequencies.

13. The system of claim 12 wherein the controller receives instructions that determine the one or more control signals, the instructions being contained in packets of bits, wherein each packet is separated into a first set of bits and a second set of bits.

14. The system of claim 13 wherein the controller receives the first set during a first period of time and the second set during a second period of time.

15. The system of claim 14 wherein the first period of time precedes the second period of time by a pause, the pause being a third period of time having a length greater than one clock cycle of a clock of the system.

16. The system of claim 15 wherein the first set contains bits corresponding to timing-critical instructions, the timing-critical instruction being instructions that should begin to be executed prior to the second time period, and wherein the controller executes the timing-critical instructions during the pause following receipt of the first set.

17. The system of claim 16 wherein the controller executes the timing-critical instructions by generating at least one control signal of the one or more control signals.

18. The system of claim 16 wherein executing the timing-critical instructions includes saving each respective bit of the first set of bits to a respective position in a register, and wherein saving each respective bit of the first set to a respective position in the register includes shifting the first set by a predetermined amount.

19. The system of claim 18 wherein the controller further generates at least one control signal of the one or more control signals based on the second set.

20. A non-transitory computer-readable medium containing thereon instructions for managing timing-critical instructions, the instructions instructing at least one processor to:
transmit a plurality of bits to a device having a switching controller, the plurality of bits being divided into a first set and a second set, by
transmit the first set during one or more first clock cycles,
perform a pause after transmitting the first set, and
transmit the second set during one or more second clock cycles;
wherein the first set contains timing-critical instructions for the device;
wherein the first set and the second set are exclusive sets of bits;
wherein the device is a switching device; and
transmitting each respective bit of the first set occurs during a respective clock cycle of the one or more first clock cycles, transmitting each respective bit of the second set occurs during a respective clock cycle of the one or more second clock cycles, and one or more timing-critical instructions corresponding to the first set are executed by the device during the pause.
